(19) United States
(12) Patent Application Publication
(10) Pub. No.: US 2025/0111120 A1
(43) Pub. Date: Apr. 3, 2025

(54) Layout Dependent Statistical Leakage Analyzing Method and Layout Dependent Statistical Leakage Analyzing System Capable of Predicting Silicon Leakage of a Block Accurately

(71) Applicant: MediaTek Singapore Pte. Ltd., Singapore (SG)

(72) Inventors: Jiayi Xu, Singapore (SG); Heng-Liang Huang, Hsinchu City (TW); Chao Xue, Singapore (SG)

(73) Assignee: MediaTek Singapore Pte. Ltd., Singapore (SG)

(21) Appl. No.: 18/898,667

(22) Filed: Sep. 26, 2024

Related U.S. Application Data
(60) Provisional application No. 63/585,998, filed on Sep. 28, 2023.

(51) Int. Cl. G06F 30/367; G06F 119/06

(52) U.S. Cl. CPC G06F 30/367; G06F 2119/06

(57) ABSTRACT

A layout dependent statistical leakage analyzing method includes providing pre-silicon data, acquiring an i-th pre-silicon leakage value of an i-th cell group according to the pre-silicon data, acquiring an (i,j)-th abutment possibility of a j-th cell group abutted on the i-th cell group according to physical information extracted from the pre-silicon data, acquiring an i-th scaling factor for a Silicon-to-SPICE (S2S) of the i-th cell group according to the pre-silicon data, acquiring an (i,j)-th layout dependent effect (LDE) factor between the i-th cell group and the j-th cell group according to the pre-silicon data and post-silicon data, and generating an estimated silicon leakage of a block according to N pre-silicon leakage values, N² abutment possibilities, N scaling factors, and N² LDE factors.

### CROSS REFERENCE TO RELATED APPLICATIONS

This application claims the benefit of U.S. Provisional Application No. 63/585,998, filed on Sep. 28, 2023. The content of the application is incorporated herein by reference.

### BACKGROUND

Modern system on a chip (SoC) designs typically include a plurality of digital domains for providing various functions. These digital domains can be regarded as functional modules or reusable units. They can be applied in logic, cell, or chip layout designs within the SoC. Notably, a leakage (or say, a power leakage) of the SoC is significant. In the SoC, each digital domain may include a plurality of digital logical circuits, such as a plurality of standard (STD) cells having corresponding threshold voltages (VTs). The STD cells play a dominant role in contributing to overall leakage of the SoC, effectively regarded as leakage sources.

In the context of advanced fin field-effect transistor (FinFET) process, currently, since layout dependent effect (LDE) and Silicon-to-SPICE (S2S) factors cannot be modeled for various digital domains, accurately predicting a silicon leakage (i.e., a P50 Si-Leakage) in digital logical circuits remains challenging. Therefore, to develop a leakage analyzing system capable of accurately predicting the leakage for various digital domains is a crucial design objective.

### SUMMARY

In an embodiment of the present invention, a layout dependent statistical leakage analyzing method is disclosed. The layout dependent statistical leakage analyzing method comprises providing pre-silicon data, acquiring an i-th pre-silicon leakage value of an i-th cell group according to the pre-silicon data, acquiring an (i,j)-th abutment possibility of a j-th cell group abutted on the i-th cell group according to physical information extracted from the pre-silicon data, acquiring an i-th scaling factor for a Silicon-to-SPICE (S2S) of the i-th cell group according to the pre-silicon data, acquiring an (i,j)-th layout dependent effect (LDE) factor between the i-th cell group and the j-th cell group according to the pre-silicon data and post-silicon data, and generating an estimated silicon leakage of a block according to N pre-silicon leakage values, N² abutment possibilities, N scaling factors, and N² LDE factors. The block comprises N cell groups. Each cell group of the N cell groups comprises at least one cell. The (i,j)-th LDE factor is determined according to physical layout displacements between the i-th cell group and the j-th cell group. N is a positive integer greater than two, N≥i and N≥j.

In another embodiment of the present invention, a layout dependent statistical leakage analyzing system is disclosed. The layout dependent statistical leakage analyzing system comprises a pre-silicon node and an analyzer. The analyzer is coupled to the pre-silicon node and configured to acquire pre-silicon data from the pre-silicon node. The analyzer comprises a processor configured to receive the pre-silicon data, and a memory coupled to the processor and configured to save a training model trained by the processor. The processor acquires an i-th pre-silicon leakage value of an i-th cell group according to the pre-silicon data. The processor acquires an (i,j)-th abutment possibility of a j-th cell group abutted on the i-th cell group according to physical information extracted from the pre-silicon data. The processor acquires an i-th scaling factor for a Silicon-to-SPICE (S2S) of the i-th cell group according to the pre-silicon data. The processor acquires an (i,j)-th layout dependent effect (LDE) factor between the i-th cell group and the j-th cell group according to the pre-silicon data and post-silicon data. The processor generates an estimated silicon leakage of a block according to N pre-silicon leakage values, N² abutment possibilities, N scaling factors, and N² LDE factors. The block comprises N cell groups. Each cell group of the N cell groups comprises at least one cell. The (i,j)-th LDE factor is determined according to physical layout displacements between the i-th cell group and the j-th cell group. Nis a positive integer greater than two, N≥i and N≥j.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a layout dependent statistical leakage analyzing system according to an embodiment of the present invention.

FIG. 2A is an illustration of a plurality of digital domain disposed in a system on a chip of the layout dependent statistical leakage analyzing system in FIG. 1.

FIG. 2B is an illustration of a plurality of cell groups of a block for a digital domain of the layout dependent statistical leakage analyzing system in FIG. 1.

FIG. 3 is an illustration of another block of the layout dependent statistical leakage analyzing system in FIG. 1.

FIG. 4 is an illustration of correlations between a percentage of a leakage Silicon-to-SPICE and subsystems under various estimation methods.

FIG. 5 is a flow chart of performing a layout dependent statistical leakage analyzing method by the layout dependent statistical leakage analyzing system in FIG. 1.

### DETAILED DESCRIPTION

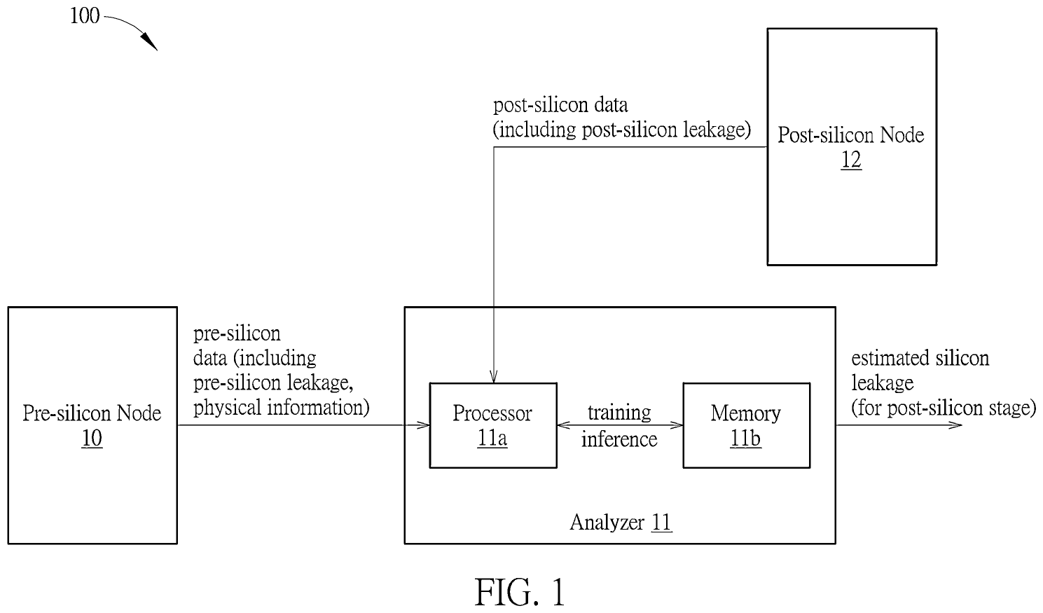

FIG. 1 is a block diagram of a layout dependent statistical leakage analyzing system 100 according to an embodiment of the present invention. The layout dependent statistical leakage analyzing system 100 can be used for accurately predicting leakage of a system on chip (SoC) for a post-silicon stage. In FIG. 1, the layout dependent statistical leakage analyzing system 100 can include a pre-silicon node 10 and an analyzer 11 coupled to the pre-silicon node 10 and configured to acquire pre-silicon data from the pre-silicon node 10. Here, the pre-silicon data can include pre-silicon leakage information and physical information of the SoC. The analyzer 11 can include a processor 11a and a memory 11b. The processor 11a is used for receiving the pre-silicon data. The memory 11b is coupled to the processor 11a for saving a training model trained by the processor 11a. For example, the training model of the layout dependent statistical leakage analyzing system 100 can be trained by the processor 11a according to the pre-silicon data of the pre-silicon node 10 and post-silicon data of a post-silicon node 12. The training model can be established by a neural network. Here, the post-silicon data can include post-silicon leakage information. In other words, the training model in the analyzer 11 of the layout dependent statistical leakage analyzing system 100 can be trained according to the pre-silicon leakage information, the physical information, and/or the post-silicon leakage information of the SoC.

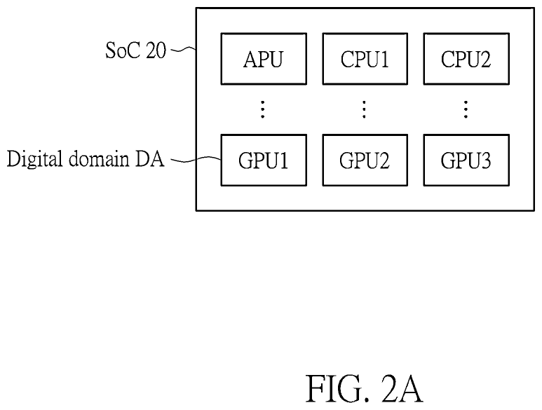

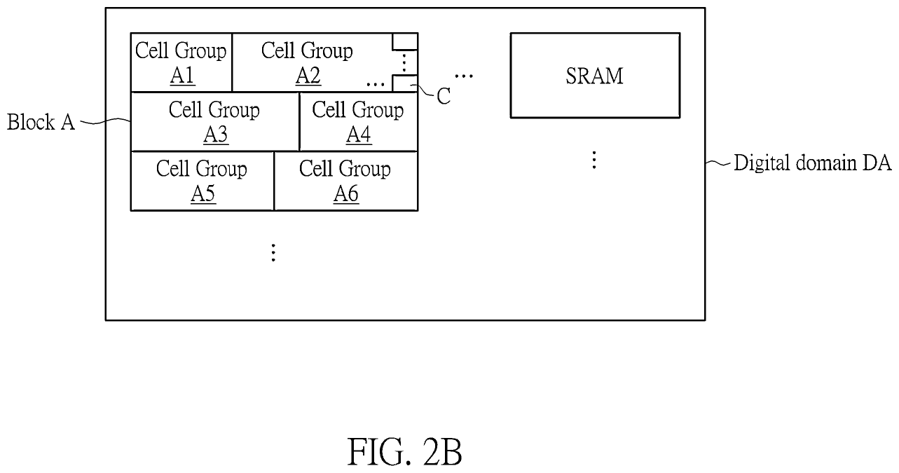

FIG. 2A is an illustration of a plurality of digital domain disposed in a system on a chip (SoC) 20 of the layout dependent statistical leakage analyzing system 100. FIG. 2B is an illustration of a plurality of cell groups A1 to A6 of a block A for a digital domain DA of the layout dependent statistical leakage analyzing system 100. Here, in FIG. 2A, the SoC 20 of the pre-silicon node 10 includes a plurality of digital domains, such as an accelerated processing unit APU, a plurality of central processing units CPU1 to CPU2, and a plurality of graphics processing units GPU1 to GPU3. For simplicity, a digital domain of the SoC 20 is called as a digital domain DA hereafter. In FIG. 2B, the digital domain DA can include a block A, a static random-access memory SRAM, and other components or embedded memory macros. The block A can include N cell groups. For example, in FIG. 2B, the block A can include cell groups A1 to A6 (here, N=6). Each cell group includes at least one cell. For example, the cell group A2 includes a plurality of cells C. It should be understood that the cell is called as a standard (STD) cell. Each cell group corresponds to a threshold voltage. For example, the cell group A1 of the block A corresponds to a threshold voltage V1. The cell group A2 of the block A corresponds to a threshold voltage V2, as so on. The cell group A6 of the block A corresponds to a threshold voltage V6. In other words, the block A includes a plurality of cells, which can be partitioned into N cell groups according to their threshold voltages. Particularly, N cell groups of the block A dominate leakage of the digital domain DA. As a result, N cell groups of the block A can be regarded as N leakage sources having different threshold voltages. Therefore, in the layout dependent statistical leakage analyzing system 100, leakage of the SoC 20 can be estimated by accurately estimating the leakage of all blocks of different digital domains. In the following, leakage estimated by each block of the SoC 20 is illustrated. In the layout dependent statistical leakage analyzing system 100, after the pre-silicon data is acquired from the pre-silicon node 10 by the processor 11a, the processor 11a can acquire an i-th pre-silicon leakage value of an i-th cell group according to the pre-silicon data. The processor 11a can acquire an (i,j)-th abutment possibility of a j-th cell group abutted on the i-th cell group according to physical information extracted from the pre-silicon data. The processor 11a can acquire an i-th scaling factor for a Silicon-to-SPICE (S2S) of the i-th cell group according to the pre-silicon data. The processor 11a can acquire an (i,j)-th layout dependent effect (LDE) factor between the i-th cell group and the j-th cell group according to the pre-silicon data and post-silicon data. The processor 11a can generate an estimated silicon leakage of a block according to N pre-silicon leakage values, N² abutment possibilities, N scaling factors, and N² LDE factors. In the layout dependent statistical leakage analyzing system 100, the (i,j)-th LDE factor can be determined according to physical layout displacements between the i-th cell group and the j-th cell group. Here, N is a positive integer greater than two, N≥i and N≥j. Details of generating the estimated silicon leakage of the block A for digital domain DA are illustrated below.

In the layout dependent statistical leakage analyzing system 100, the estimated silicon leakage of the block A for digital domain DA can be expressed by:

$$EstSiLkg = {\sum }_{i = 1}^{n} {\sum }_{j = 1}^{m} {PreSi\_Lkg}_{i} * {Prob\_Abut}_{ij} * S 2 {S}_{i} * 2 D\_LDE {\_Factor}_{ij}$$

Here, PreSi_Lkgᵢ is the i-th pre-silicon leakage value of the i-th cell group. Prob_Abutᵢⱼ is the (i,j)-th abutment possibility of the j-th cell group abutted on the i-th cell group. S2Sᵢ is the i-th scaling factor for the S2S of the i-th cell group. 2D_LDE_Factoryᵢⱼ is the (i,j)-th LDE factor between the i-th cell group and the j-th cell group. In the layout dependent statistical leakage analyzing system 100, the processor 11a determines the i-th pre-silicon leakage value PreSi_Lkgᵢ of the i-th cell group according to a threshold voltage of the i-th cell group by using a power analysis tool (PTPX) with a library under a SPICE model. The (i,j)-th abutment possibility Prob_Abutᵢⱼ of the j-th cell group abutted on the i-th cell group is a percentage number smaller than one. For example, according to physical statistic information of the block A acquired from the pre-silicon data, an abutment possibility Prob_Abut₃₁ of the cell group A3 abutted on the cell group A1 can be equal to 15%. An abutment possibility Prob_Abut₃₂ of the third cell group A3 abutted on the cell group A2 can be equal to 10%. Since N≥i and N≥j are introduced, N² abutment possibilities can be determined for all combinations of the cell groups. Further, the processor 11a can determine the i-th scaling factor S2Sᵢ for the S2S of the i-th cell group by collecting silicon test key data or wafer acceptance test (WAT) data, or by using S2S online sensors. The WAT data can include intra-LDE data and inter-LDE data. Specifically, the i-th scaling factor S2Sᵢ for the S2S can be used for calibrating the estimated silicon leakage closer to real silicon testing results. Further, the processor 11a can train the training model according to the pre-silicon data and the post-silicon data. The processor 11a can use the training model for generating the (i,j)-th LDE factor 2D_LDE_Factoryᵢⱼ according to a physical cell group abutment environment between the i-th cell group and the j-th cell group acquired from the pre-silicon data and the post-silicon data. It should be understood that the LDE factor can be defined as electrical variations induced by altering layout parameters, such as a spacing gap between gates, a length of diffusion area, and/or positions of N/P wells. In the layout dependent statistical leakage analyzing system 100, a “two-dimensional” LDE factor (say, the (i,j)-th LDE factor 2D_LDE_Factoryᵢⱼ) can be regarded as the LDE factor corresponding to pair-wised cell groups according to their physical cell group abutment environment. Therefore, the processor 11a can change the (i,j)-th LDE factor 2D_LDE_Factoryᵢⱼ when the physical cell group abutment environment between the i-th cell group and the j-th cell group is changed, such as (3,1)-th LDE factor (1,3)-th LDE factor. Here, the physical cell group abutment environment between the i-th cell group and the j-th cell group includes a horizontal physical cell group abutment environment in a horizontal direction and a vertical physical cell group abutment environment in a vertical direction. In the embodiment, the (i,j)-th LDE factor 2D_LDE_Factoryᵢⱼ between the i-th cell group and the j-th cell group is non-flat LDE factor for different cell group pairs or blocks. Further, in the layout dependent statistical leakage analyzing system 100, the analyzer 11 can infer accurate leakage estimation of each digital domain in the SoC. Particularly, the pre-silicon data includes physical data of each of the N cell groups in the block after an automatic placement and routing (APR) stage is performed. Any reasonable technology or hardware modification falls into the scope of the present invention.

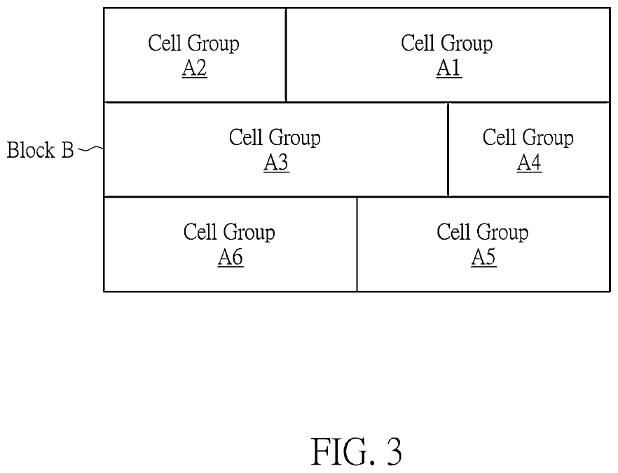

FIG. 3 is an illustration of another block of the layout dependent statistical leakage analyzing system 100. To avoid ambiguity, another block in FIG. 3 is called as a block B. As previously mentioned, the processor 11a can use the training model for generating the (i,j)-th LDE factor 2D_LDE_Factoryᵢⱼ between the i-th cell group and the j-th cell group according to their physical cell group abutment environment. The block A in FIG. 2B includes the cell group A1 to the cell group A6. Similarly, the block B in FIG. 3 includes the cell group A1 to the cell group A6. In other words, the block A and the block B have the same cell group list. However, the block A and the block B have different physical cell group abutment environments. Since the block A and the block B have different physical cell group abutment environments, the block A and the block B correspond to different two-dimensional LDE factor sets. For example, a two-dimensional LDE factor set S1 of the block A includes 36 LDE factors (for i=1˜6 and j=1˜6). A two-dimensional LDE factor set S2 of the block A includes 36 LDE factors (for i=1˜6 and j=1˜6). However, although the block A and the block B have the same cell group list, the two-dimensional LDE factor set S1 and the two-dimensional LDE factor set S2 are different.

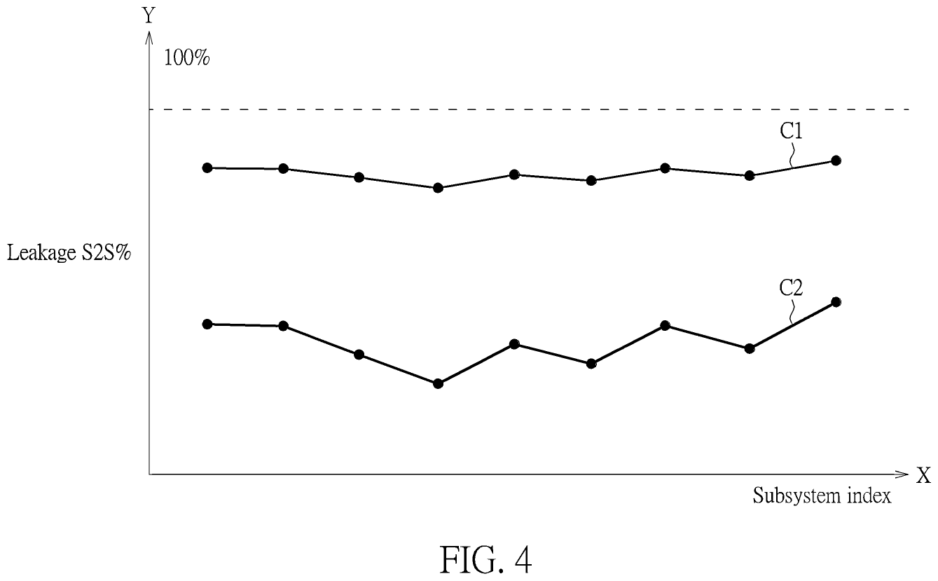

FIG. 4 is an illustration of correlations between a percentage of a leakage Silicon-to-SPICE and subsystems under various estimation methods. In FIG. 4, X-axis denotes as a subsystem index. Y-axis denotes as the percentage of the leakage S2S. The subsystem index can be defined as a digital domain index. The percentage of the leakage S2S can be regarded as an accuracy scale of estimating the silicon leakage. The percentage of the leakage S2S can be expressed as:

$$\frac{Actual silicon leakage}{Estimated silicon leakage}$$

For ideal case, if the estimated silicon leakage is equal to the actual silicon leakage, the percentage of the leakage S2S is 100%. In FIG. 4, a curve C1 denotes a percentage of a leakage S2S corresponding to the inter-cell LDE factor and the intra-cell LDE factor generated by the layout dependent statistical leakage analyzing system 100. A curve C2 denotes a percentage of a leakage S2S corresponding to conventional flat LDE factors. Particularly, an estimation accuracy of the curve C1 is greater than an estimation accuracy of the curve C2. In other words, an “individual subsystem” leakage S2S of the layout dependent statistical leakage analyzing system 100 can be improved, approaching 100%. Further, an estimation variation of the curve C1 is smaller than an estimation variation of the curve C2. In other words, a “cross subsystem” leakage S2S of the layout dependent statistical leakage analyzing system 100 has smaller variation. As a result, the layout dependent statistical leakage analyzing system 100 can provide high accuracy and high stability for predicting the silicon leakage for various digital domains.

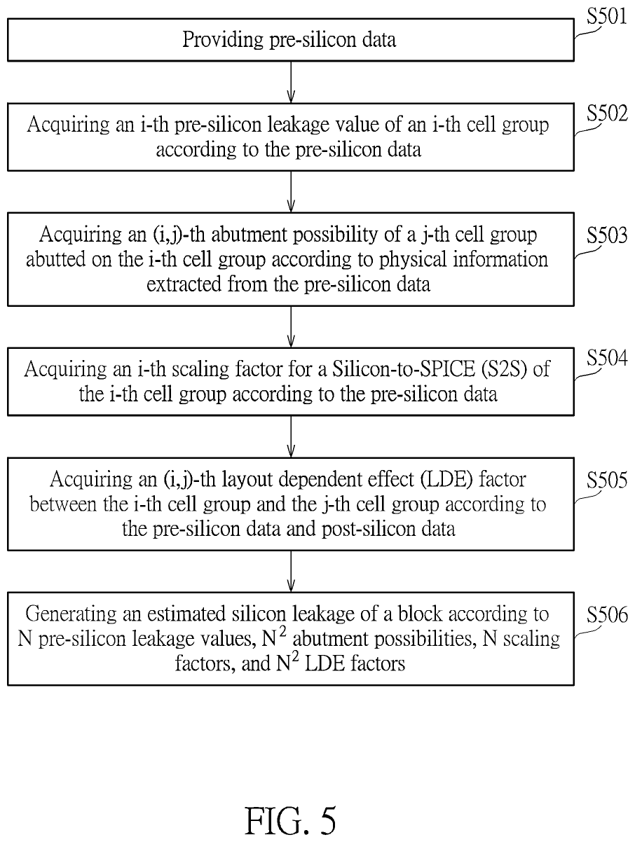

FIG. 5 is a flow chart of performing a layout dependent statistical leakage analyzing method by the layout dependent statistical leakage analyzing system 100. The layout dependent statistical leakage analyzing method includes step S501 to step S506. Any reasonable technology or hardware modification falls into the scope of the preset invention. Step S501 to step S506 are illustrated below.
step S501: providing pre-silicon data;
step S502: acquiring an i-th pre-silicon leakage value of an i-th cell group according to the pre-silicon data;
step S503: acquiring an (i,j)-th abutment possibility of a j-th cell group abutted on the i-th cell group according to physical information extracted from the pre-silicon data;
step S504: acquiring an i-th scaling factor for a Silicon-to-SPICE (S2S) of the i-th cell group according to the pre-silicon data;
step S505: acquiring an (i,j)-th layout dependent effect (LDE) factor between the i-th cell group and the j-th cell group according to the pre-silicon data and post-silicon data;
step S506: generating an estimated silicon leakage of a block according to N pre-silicon leakage values, N² abutment possibilities, N scaling factors, and N² LDE factors.

Details of step S501 to step S506 are previously illustrated. Thus, they are omitted here. In the layout dependent statistical leakage analyzing system 100, since the N pre-silicon leakage values, N² abutment possibilities, N scaling factors, and N² LDE factors are used for estimating and predicting the silicon leakage, the estimated silicon leakage is relevant to the abutment environment of the N cell groups. As a result, the layout dependent statistical leakage analyzing system 100 can provide high accuracy and high stability for predicting the silicon leakage for various digital domains.

To sum up, the present invention discloses a layout dependent statistical leakage analyzing method and a layout dependent statistical leakage analyzing system. Instead of using fixed LDE factors, the layout dependent statistical leakage analyzing system introduces non-flat two-dimensional LDE factors associated with abutment environment of the N cell groups of the block. Therefore, an estimated silicon leakage of the block is sensitive to the physical environment of the N cell groups. For example, even if two blocks have the same cell list, their estimated silicon leakages are different. As a result, the layout dependent statistical leakage analyzing system can provide high accuracy and high stability for predicting the silicon leakage for various digital domains.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A layout dependent statistical leakage analyzing method comprising:
providing pre-silicon data;
acquiring an i-th pre-silicon leakage value of an i-th cell group according to the pre-silicon data;
acquiring an (i,j)-th abutment possibility of a j-th cell group abutted on the i-th cell group according to physical information extracted from the pre-silicon data;
acquiring an i-th scaling factor for a Silicon-to-SPICE (S2S) of the i-th cell group according to the pre-silicon data;
acquiring an (i,j)-th layout dependent effect (LDE) factor between the i-th cell group and the j-th cell group according to the pre-silicon data and post-silicon data; and
generating an estimated silicon leakage of a block according to N pre-silicon leakage values, N² abutment possibilities, N scaling factors, and N² LDE factors;
wherein the block comprises N cell groups, each cell group of the N cell groups comprises at least one cell, the (i,j)-th LDE factor is determined according to physical layout displacements between the i-th cell group and the j-th cell group, N is a positive integer greater than two, N≥i and N≥j.

2. The method of claim 1, wherein the estimated silicon leakage of the block is expressed by
$$EstSiLkg = {\sum }_{i = 1}^{n} {\sum }_{j = 1}^{m} {PreSi\_Lkg}_{i} * {Prob\_Abut}_{ij} * S 2 {S}_{i} * 2 D\_LDE {\_Factor}_{ij}$$
wherein PreSi_Lkgᵢ is the i-th pre-silicon leakage value of the i-th cell group, Prob_Abutᵢⱼ is the (i,j)-th abutment possibility of the j-th cell group abutted on the i-th cell group, S2Sᵢ is the i-th scaling factor for the S2S of the i-th cell group, 2D_LDE_Factoryᵢⱼ is the (i,j)-th LDE factor between the i-th cell group and the j-th cell group.

3. The method of claim 1, further comprising:
determining the i-th pre-silicon leakage value of the i-th cell group according to a threshold voltage of the i-th cell group by using a power analysis tool (PTPX) with a library under a SPICE model.

4. The method of claim 1, wherein the (i,j)-th abutment possibility of the j-th cell group abutted on the i-th cell group is a percentage number smaller than one.

5. The method of claim 1, further comprising:
determining the i-th scaling factor for the S2S of the i-th cell group by collecting silicon test key data or wafer acceptance test (WAT) data;
wherein the WAT data comprises intra-LDE data and inter-LDE data, and the i-th scaling factor for the S2S is used for calibrating the estimated silicon leakage closer to real silicon testing results.

6. The method of claim 1, further comprising:
providing a training model trained by the pre-silicon data and the post-silicon data; and
using the training model for generating the (i,j)-th LDE factor according to a physical cell group abutment environment between the i-th cell group and the j-th cell group acquired from the pre-silicon data and the post-silicon data.

7. The method of claim 6, further comprising:
changing the (i,j)-th LDE factor when the physical cell group abutment environment between the i-th cell group and the j-th cell group is changed.

8. The method of claim 6, wherein the physical cell group abutment environment between the i-th cell group and the j-th cell group comprises a horizontal physical cell group abutment environment in a horizontal direction and a vertical physical cell group abutment environment in a vertical direction.

9. The method of claim 1, wherein the pre-silicon data comprises physical data of each cell group of the N cell groups in the block after an automatic placement and routing (APR) stage is performed.

10. The method of claim 1, wherein the (i,j)-th LDE factor between the i-th cell group and the j-th cell group is non-flat LDE factor for different cell group pairs or blocks.

11. A layout dependent statistical leakage analyzing system comprising:
a pre-silicon node; and
an analyzer coupled to the pre-silicon node and configured to acquire pre-silicon data from the pre-silicon node, the analyzer comprising:
a processor configured to receive the pre-silicon data; and
a memory coupled to the processor and configured to save a training model trained by the processor;
wherein the processor acquires an i-th pre-silicon leakage value of an i-th cell group according to the pre-silicon data, the processor acquires an (i,j)-th abutment possibility of a j-th cell group abutted on the i-th cell group according to physical information extracted from the pre-silicon data, the processor acquires an i-th scaling factor for a Silicon-to-SPICE (S2S) of the i-th cell group according to the pre-silicon data, the processor acquires an (i,j)-th layout dependent effect (LDE) factor between the i-th cell group and the j-th cell group according to the pre-silicon data and post-silicon data, the processor generates an estimated silicon leakage of a block according to N pre-silicon leakage values, N² abutment possibilities, N scaling factors, and N² LDE factors, the block comprises N cell groups, each cell group of the N cell groups comprises at least one cell, the (i,j)-th LDE factor is determined according to physical layout displacements between the i-th cell group and the j-th cell group, N is a positive integer greater than two, N≥i and N≥j.

12. The system of claim 11, wherein the estimated silicon leakage of the block is expressed by
$$EstSiLkg = {\sum }_{i = 1}^{n} {\sum }_{j = 1}^{m} {PreSi\_Lkg}_{i} * {Prob\_Abut}_{ij} * S 2 {S}_{i} * 2 D\_LDE {\_Factor}_{ij}$$
wherein PreSi_Lkgᵢ is the i-th pre-silicon leakage value of the i-th cell group, Prob_Abutᵢⱼ is the (i,j)-th abutment possibility of the j-th cell group abutted on the i-th cell group, S2Sᵢ is the i-th scaling factor for the S2S of the i-th cell group, 2D_LDE_Factoryᵢⱼ is the (i,j)-th LDE factor between the i-th cell group and the j-th cell group.

13. The system of claim 11, wherein the processor determines the i-th pre-silicon leakage value of the i-th cell group according to a threshold voltage of the i-th cell group by using a power analysis tool (PTPX) with a library under a SPICE model.

14. The system of claim 11, wherein the (i,j)-th abutment possibility of the j-th cell group abutted on the i-th cell group is a percentage number smaller than one.

15. The system of claim 11, wherein the processor determines the i-th scaling factor for the S2S of the i-th cell group by collecting silicon test key data or wafer acceptance test (WAT) data, and the WAT data comprises intra-LDE data and inter-LDE data, and the i-th scaling factor for the S2S is used for calibrating the estimated silicon leakage closer to real silicon testing results.

16. The system of claim 11, wherein the processor trains the training model according to the pre-silicon data and the post-silicon data, and the processor uses the training model for generating the (i,j)-th LDE factor according to a physical cell group abutment environment between the i-th cell group and the j-th cell group acquired from the pre-silicon data and the post-silicon data.

17. The system of claim 16, wherein the processor changes the (i,j)-th LDE factor when the physical cell group abutment environment between the i-th cell group and the j-th cell group is changed.

18. The system of claim 16, wherein the physical cell group abutment environment between the i-th cell group and the j-th cell group comprises a horizontal physical cell group abutment environment in a horizontal direction and a vertical physical cell group abutment environment in a vertical direction.

19. The system of claim 11, wherein the pre-silicon data comprises physical data of each cell group of the N cell groups in the block after an automatic placement and routing (APR) stage is performed.

20. The system of claim 11, wherein the (i,j)-th LDE factor between the i-th cell group and the j-th cell group is non-flat LDE factor for different cell group pairs or blocks.
